(19) United States
(12) Patent Application Publication
(10) Pub. No.: US 2018/0099815 A1
(43) Pub. Date: Apr. 12, 2018

(54) GRAIN BIN SPREADER WITH DOMED BELL

(71) Applicant: Spread All Manufacturing Co., Marshalltown, IA (US)

(72) Inventor: Brian Maddick, Marshalltown, IA (US)

(21) Appl. No.: 15/291,910

(22) Filed: Oct. 12, 2016

(51) Int. Cl. B65G 21/20; B65G 69/04

(52) U.S. Cl. CPC B65G 21/20; B65G 2201/042; B65G 69/0458

(57) ABSTRACT

A grain spreader for a grain bin is provided with an electric motor having a domed or conical cap. The inclination of the cap is preferably 45°. The inclination of the cap eliminates grain splattering and minimizes wear on the cap. The cap includes an internal hub with an axial cavity. A bearing is mounted within the cavity to rotatably support an upper end of the motor drive shaft.

### FIELD OF THE INVENTION

The present invention is directed to a grain spreader used in a grain bin during the harvest season. More particularly, the invention relates to an improved cover for an electric motor of the grain spreader.

### BACKGROUND OF THE INVENTION

Grain spreaders are commonly used in grain bins to facilitate the even and substantially level distribution of grain into the bin. More particularly, the grain spreader is mounted to the roof of the grain bin, just below the roof opening. Grain from a conveyor, commonly a belt or auger, is discharged through the roof opening into the spreader. The spreader includes a funnel or inverted cone which deposits the grain onto a rotating plate or arm which throws the grain evenly across the full width of the grain bin as the plate or arm rotates. Ideally, the spreader creates a substantially level spread pattern for the grain, which may be slightly depressed in the center of the bin, and without significant build up adjacent the bin walls.

There are two general types of prior art grain spreaders: gravity flow and motorized. In the latter, an electric motor is mounted within the spreader funnel with an output shaft extending downwardly and connected to the spreader plate or arm so as to rotate the plate or arm when the motor is actuated. The motor has a flat upper cap. The flat surface of the cap causes grain splattering, which in essence, is uncontrolled bouncing of the seed off the cap and over the spreader cone into the grain bin, or out through the roof opening onto the ground. The cap is also subjected to excessive wear caused by the impingement of grain being dropped from the conveyor into the spreader. Grain is very abrasive. A motor cap can be worn out over time, after as little as one million bushels, or less. Such splattering and cap wear are undesirable.

Accordingly, a primary objective of the present invention is the provision of an improved grain spreader which overcomes the problems of the prior art.

Another objective of the present invention is the provision of a grain spreader having an electric motor with a conical cap.

A further objective of the present invention is the provision of a domed cap for electrical motor of a grain spreader.

Still another objective of the present invention is the provision of a grain spreader which eliminates grain splattering.

Yet another objective of the present invention is the provision of a grain spreader having an electric motor with an upper cap which avoids excessive wear.

Another objective of the present invention is the provision of an improved grain spreader which is economical to manufacture, and is safe, efficient, and durable in use.

These and other objectives have become apparent to the following description of the invention.

### SUMMARY OF THE INVENTION

A grain spreader for a grain bin is provided with an electric motor having a conical or domed cap or cover on the upper end of the motor. The angle of inclination of the cap is preferably 45°, which eliminates grain splattering and minimizes cap wear. The cap includes an internal central hub with an axially extending cavity to receive one end of the motor drive shaft.

### BRIEF DESCRIPTION OF THE DRAWINGS

FIG. 1 is a schematic view of a grain spreader for use in a grain bin, with the improved motor cap of the present invention.

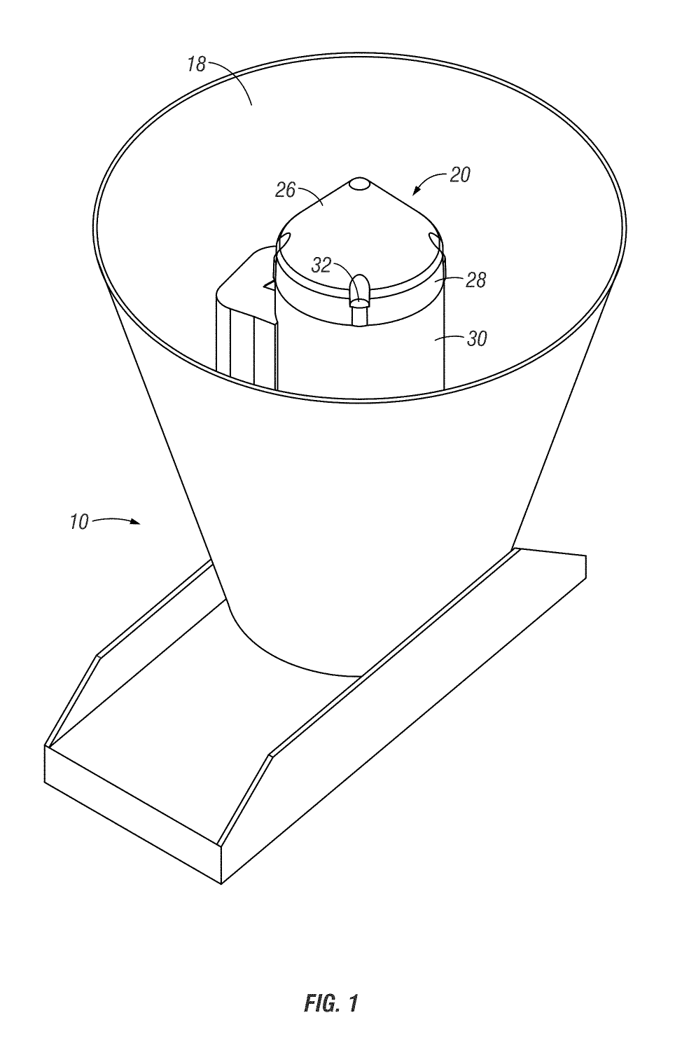

FIG. 2 is a perspective view of the motor with a conical cap of the present invention.

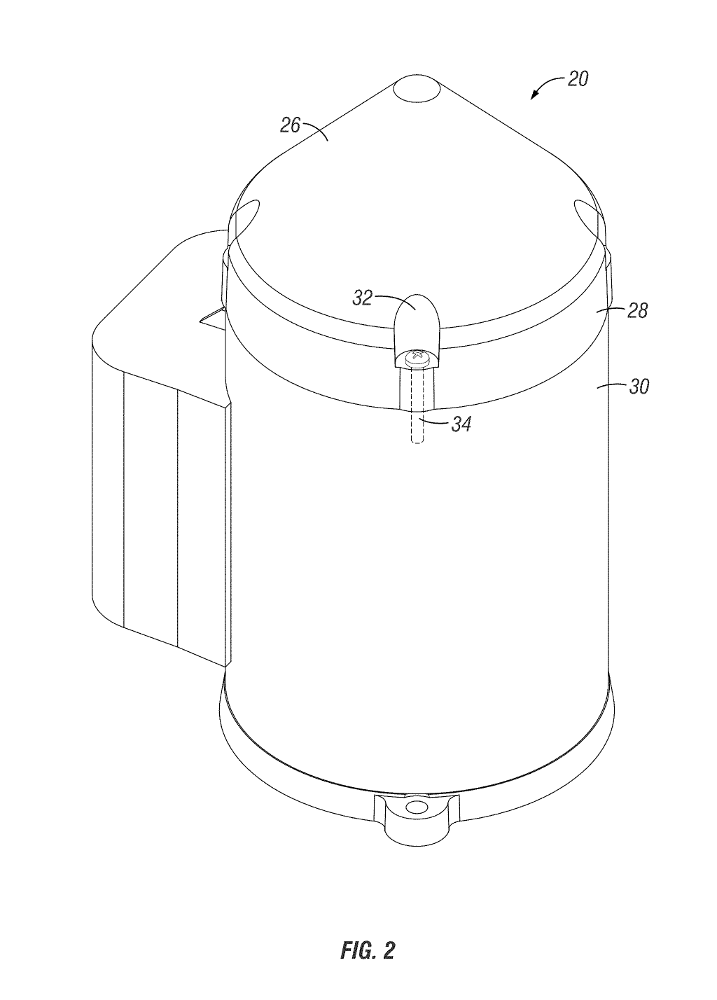

FIG. 3 is a side elevation view of the motor with the conical cap of the present invention.

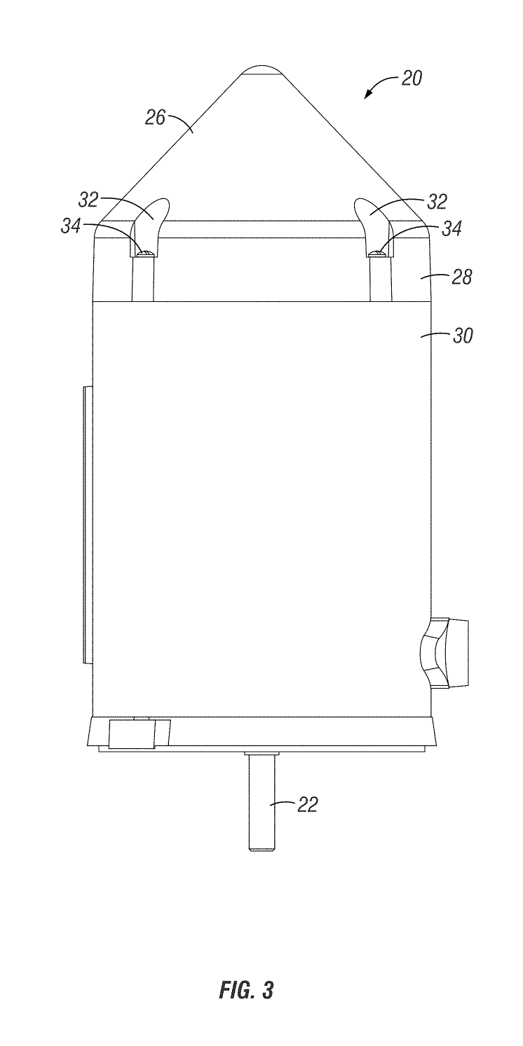

FIG. 4 is a perspective view of the cap.

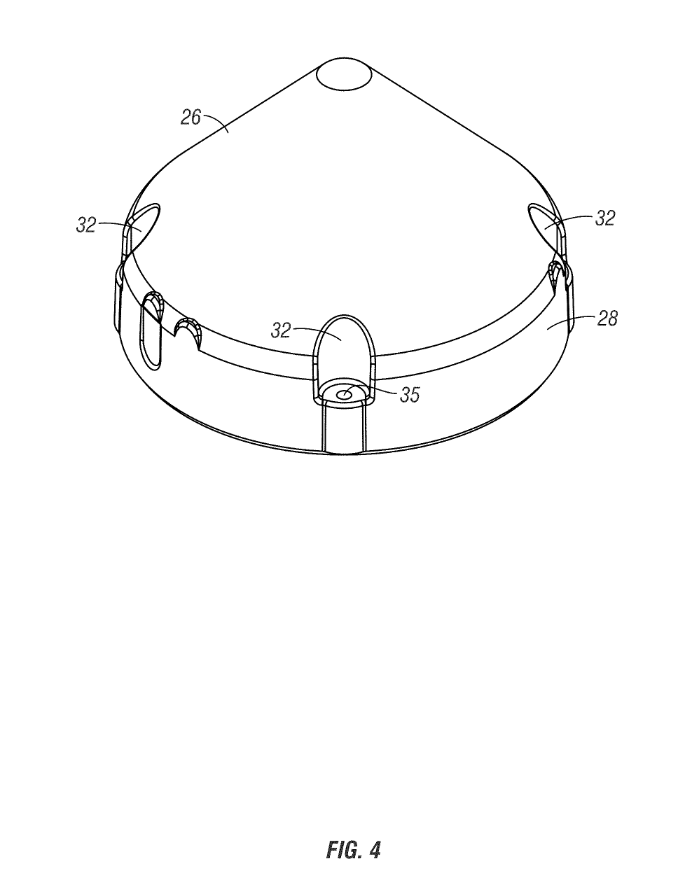

FIG. 5 is a top view of the cap.

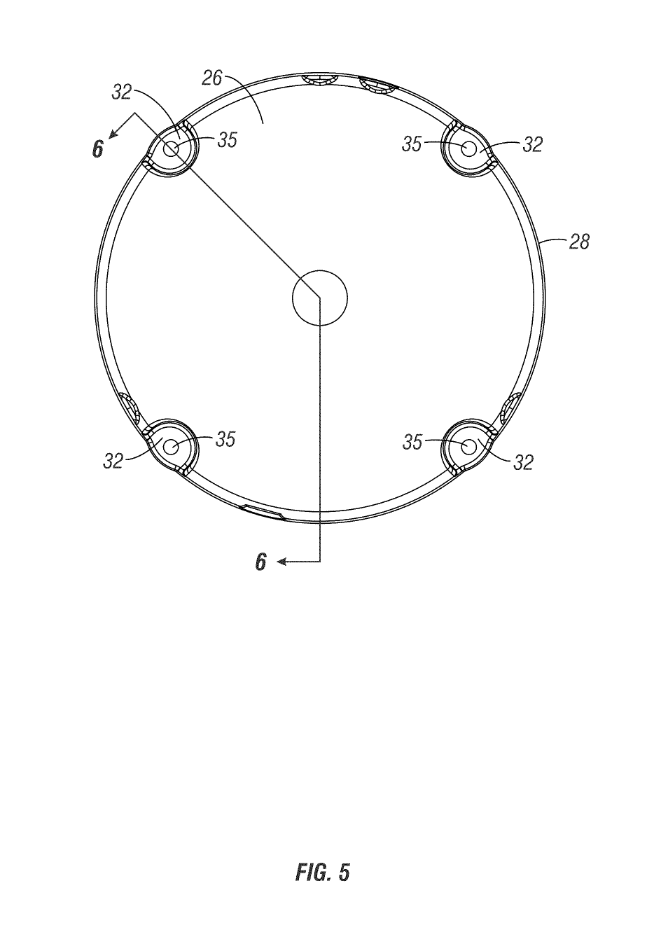

FIG. 6 is a sectional view of the cap taken along lines 6-6 of FIG. 5.

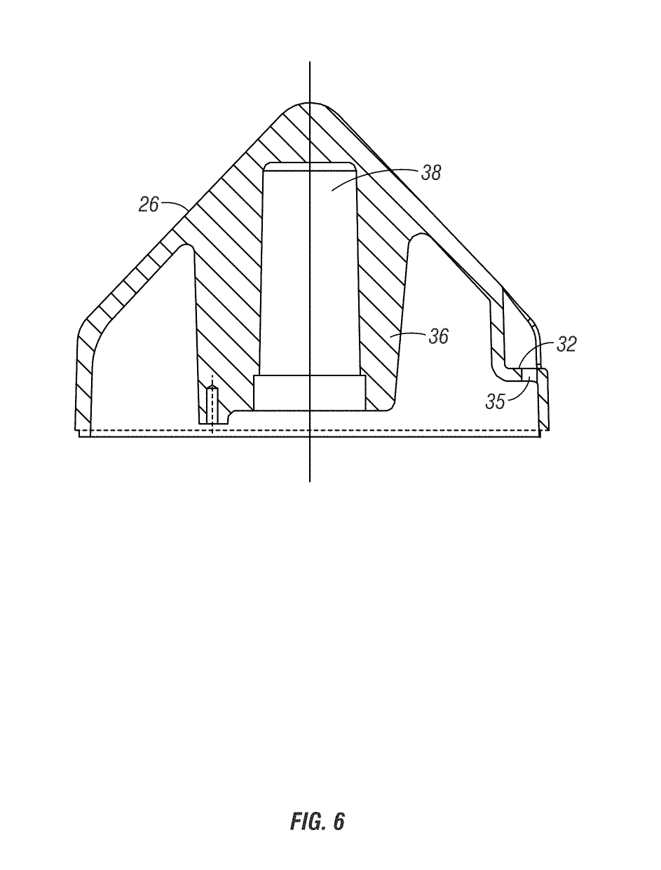

FIG. 7 is a sectional view showing the motor mounted in the funnel of the grain spreader.

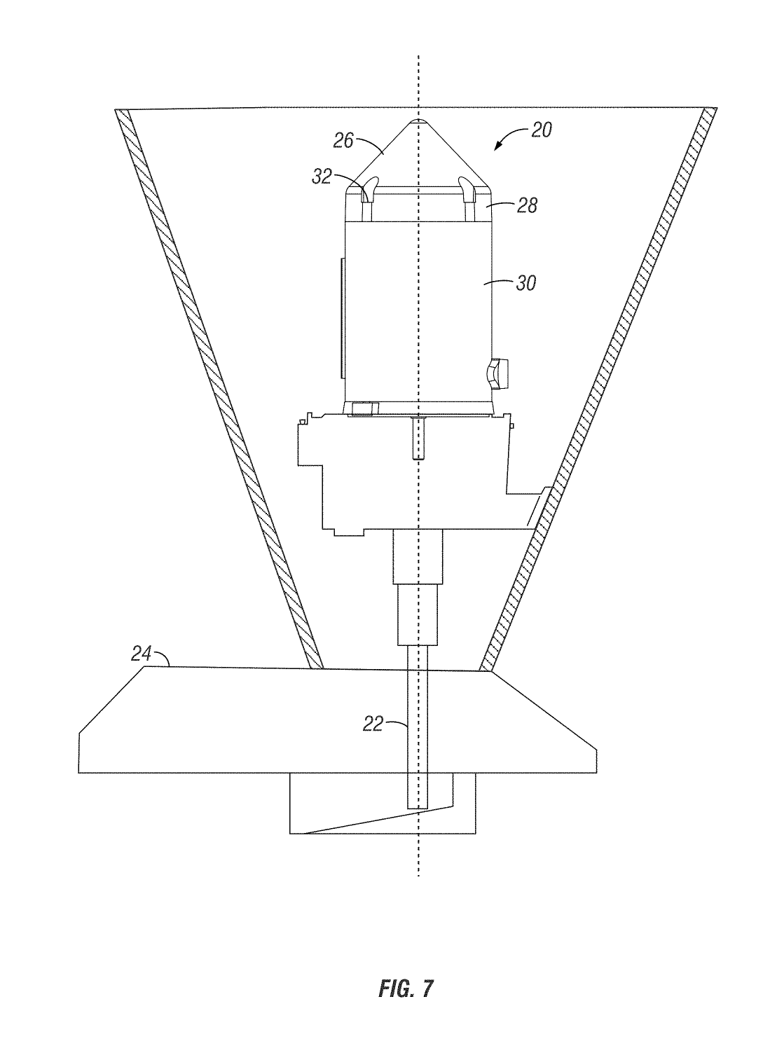

FIG. 8 is a view showing the grain spreader mounted in a grain bin.

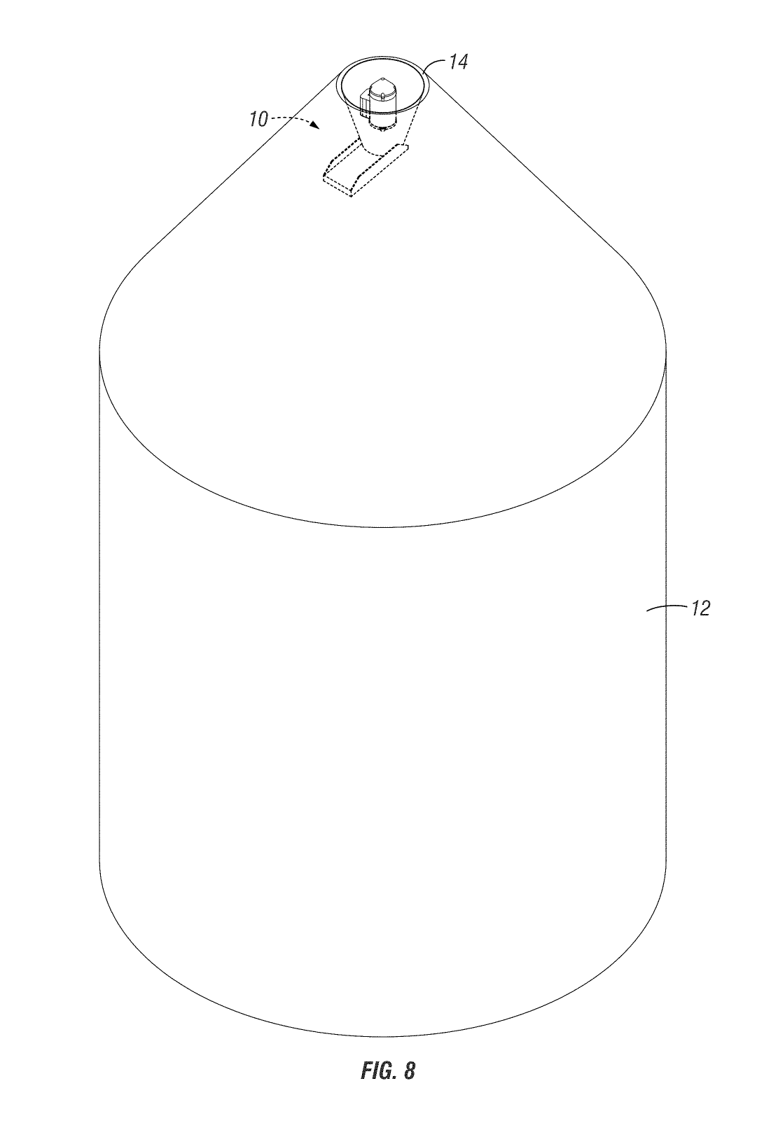

### DETAILED DESCRIPTION OF THE PREFERRED EMBODIMENTS

The present invention is directed towards a grain spreader 10 mounted to the roof of a grain bin 12 immediately below the roof opening 14 so as to receive grain from a conveyor 16. The grain spreader 10 includes a funnel-shaped hopper 18 with an electrical motor 20 mounted within the funnel 18. The motor 20 is oriented such that the output or drive shaft 22 extends vertically. A distribution plate or arm 24 is connected to the lower end of the drive shaft 22, such that actuation of the motor 20 imparts rotation to the plate or arm 24. Thus, grain discharged from the conveyor 16 into the funnel 18 flows by gravity onto the rotating plate or arm 24 so as to create an even distribution of the grain within the grain bin 12.

The above structure and function of the grain spreader 10 is conventional, and does not constitute a part of the present invention.

The present invention improves the grain spreader 10 by providing a conical or domed cap or cover 26 on the upper end of the motor 20. In the drawings, the cap 26 is shown to have an inclination of approximately 45°. However, it is understood that this inclination can vary from that shown in the drawings, approximately ±20°.

The cap or cover 26 includes a cylindrical sidewall 28 which engages with the sidewall 30 of the motor 20. Recesses 32 maybe be formed in the cap 26, to allow fasteners, such as bolts 34, to extend through a bolt hole 35 to threadably connect the cap 26 to the motor 20.

The cap or cover 26 is substantially hollow. A cylindrical hub 36 is formed on the interior of the cap 26. The hub 36 includes an axially extending cavity 38, with a bearing (not shown) mounted in the cavity to rotatably support the upper end of the drive shaft 22.

With the domed cover 26 on the motor 20 of the grain spreader 10, splattering of grain outside the funnel 18 is virtually eliminated. Furthermore, the inclination of the cover 26 substantially reduces or eliminates wear on the motor cover, compared to the conventional flat motor covers sued in motorized grain spreaders.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

What is claimed is:

1. A grain spreader motor, comprising:
a body with opposite upper and lower ends; and
a domed cover on the upper end.

2. The grain spreader motor of claim 1 wherein the cover includes recesses to receive fasteners for mounting the cover to the body.

3. The grain spreader motor of claim 1 wherein the cover extends approximately 45°.

4. The grain spreader motor of claim 1 wherein the cover has a pointed tip.

5. The grain spreader motor of claim 1 wherein the cover includes a cylindrical sidewall for mating engagement with the body, and an inclined conical wall terminating in a tip.

6. The grain spreader motor of claim 1 where the cover has a central internal hub.

7. The grain spreader motor of claim 6 wherein the hub includes an axially extending cavity.

8. A grain spreader for distributing grain in a grain bin, comprising:
a funnel shaped hopper;
a motor mounted inside the hopper and having an output shaft;
a plate mounted below the hopper and being connected to the output shaft for rotation upon actuation of the motor; and the motor having a conical cap to mitigate splattering of seed deposited into the funnel.

9. The grain spreader of claim 8 wherein the hopper has an upper end, and the cap has an apex below the upper end.

10. The grain spreader of claim 8 wherein the output shaft extends downwardly.

11. The grain spreader of claim 8 wherein the output shaft extends vertically.

12. The grain spreader of claim 8 wherein the cap has a surface inclined at approximately 45°.

13. The grain spreader of claim 8 wherein the cap is substantially hollow.

14. The grain spreader of claim 8 wherein the cap has an axially extending, cylindrical, internal collar.

15. A method of loading grain into a grain bin, comprising:
discharging grain from a conveyor through a roof opening in the bin into a grain spreader;
deflecting the grain entering the spreader with a conical cap of an electric motor;
draining the grain from the spreader onto a rotating plate so as to throw the grain around the inside of the bin.

16. The method of claim 15 wherein the grain spreader includes a conical hopper, and the grain flows by gravity into and out of the hopper.

17. The method of claim 15 wherein the plate is rotated by the motor.

18. The method of claim 15 wherein the cap has a surface sloped at about 45° for deflecting the grain.

19. The method of claim 15 wherein the cap precludes accumulation of grain on top of the motor.

20. The method of claim 15 wherein the grain is free from splattering out of the spreader.
